(19) United States
(12) Patent Application Publication
(10) Pub. No.: US 2014/0244278 A1
(43) Pub. Date: Aug. 28, 2014

(54) HEALTH MANAGEMENT SYSTEM AND METHOD OF PROVIDING HEALTH INFORMATION BY USING THE SYSTEM

(71) Applicant: Electronics and Telecommunications Research Institute, Daejeon (KR)

(72) Inventors: Chan Yong PARK, Daejeon (KR); Joon-Ho LIM, Daejeon (KR)

(21) Appl. No.: 13/910,972

(22) Filed: Jun. 5, 2013

(30) Foreign Application Priority Data
Feb. 25, 2013 (KR) 10-2013-0019919

(51) Int. Cl. G06F 19/00

(52) U.S. Cl. CPC G06F 19/3431
USPC 705/2

(57) ABSTRACT

Provided are a health management system of estimating a disease probability of a user based on information collected from the user and a method of providing health information by using the health management system. The health management system includes a user device collecting and providing health data and living data of a user and a health information processing device calculating a disease probability of the user by performing statistic analysis based on an electric medical record and the health data and correcting the calculated disease probability according to the living data. The living data includes one of location information of the user and social information of the user, which designates a human connection.

### CROSS-REFERENCE TO RELATED APPLICATIONS

This U.S. non-provisional patent application claims priority under 35 U.S.C. §119 of Korean Patent Application No. 10-2013-0019919, filed on Feb. 25, 2013, the entire contents of which are hereby incorporated by reference.

### BACKGROUND OF THE INVENTION

The present invention relates to a health management system, and more particularly, to a health management system notifying a disease probability occurrence of a user and a method of providing health information by using the system.

Medical institutions keep medical records including a name of disease, a symptom, a body temperature, and blood pressure after treating a patient. Kept medical records may be used when treating the same patient to refer a medical history, a physical constitution, administrated medicines, and a curative influence of the patient.

As computerization facilities have been developed and supplied, electric medical record systems of computerizing and storing medical records in computers have been provided. Typical electric medical record systems are just computerizing and storing medical records and but is limited to simply store medical records and to provide convenience of retrieving.

### SUMMARY OF THE INVENTION

The present invention provides a health management system of diagnosing health data transmitted from a user based on documents obtained by statistically analyzing an electrical medical record and notifying the user a disease probability of the user and a method of providing health information by using the health management system.

The present invention also provides a health management system of diagnosing a disease probability of a user and notifying the user, based on health data and living data of the user, and a method of providing health information by using the health management system.

Embodiments of the present invention provide health management systems including a user device collecting and providing health data and living data of a user and a health information processing device calculating a disease probability of the user by performing statistic analysis based on an electric medical record and the health data and correcting the calculated disease probability according to the living data. The living data includes one of location information of the user and social information of the user, which designates a human connection.

In some embodiments, the health information processing device may calculate a mean disease factor of a predetermined area based on disease probabilities of people located in the predetermined area and may determine whether the user is located in the predetermined area with reference to the living data. When the user is located in the predetermined area, the mean disease factor may be updated with reference to the disease probability of the user and the disease probability of the user may be corrected according to the updated mean disease factor.

In other embodiments, the health information processing device may determine contiguity of the user and the object with reference to the living data and may correct the disease probability of the user with reference to the contiguity and a disease probability of the object.

In still other embodiments, the living data may include a social relation between the user and the object in a social network service (SNS).

In even other embodiments, the health information processing device may include a database storing one of the health data and the living data.

In yet other embodiments, the disease probability may be a probability of a transmittable disease.

In further embodiments, the health information processing device may provide a clinical diagnosis result to the user device, based on the calculated disease probability of the user.

In still further embodiments, the health information processing device may determine an estimation function according to a result of performing the statistic analysis and may calculate the disease probability of the user by applying the determined estimation function to the collected health data.

In even further embodiments, the health information processing device may select at least one of a plurality of risk variables as a variable of a provisional estimation function, may perform the statistic analysis with respect to a result of applying the provisional estimation function to the electric medical record, and may determine the provisional estimation function to be the estimation function according to a result of performing the statistic analysis.

In yet further embodiments, the statistic analysis may be performed by using one of regression analysis and a support vector machine (SVM) algorithm.

In much further embodiments, the health management system may further include an electric medical record storage device storing the electric medical record and providing the electric medical record to the health information processing device in response to a request of the health information processing device.

In other embodiments of the present invention, methods of providing health information by using a health management system include calculating disease probability of a user by statistically analyzing an electric medical record and health data of the user, correcting the disease probability of the user with reference to living data of the user, and providing a clinical determination with respect to a disease to the user according to the corrected disease probability. The living data may include one of location information of the user and social information of the user, designating a human connection.

In some embodiments, the correcting the disease probability may include updating a mean disease factor showing a risk of disease transmission of an area in which the user is located, with reference to the location information of the user and the disease probability of the user and correcting the disease probability of the user according to the updated mean disease factor.

In other embodiments, the correcting the disease probability may include determining contiguity between the user and an object with reference to the social information and correcting the disease probability of the user with reference to the contiguity and a disease probability of the object.

In still other embodiments, the calculating the disease probability may include selecting some of a plurality of risk variables, verifying a correlation between the selected risk variable and the disease probability by statistically analyzing the electric medical record according to the selected risk variable, determining an estimation function comprising the selected risk variable according to a verification result, and calculating the disease probability of the user by applying the estimation function to the health data of the user.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block view illustrating a health management system according to an embodiment of the present invention;

FIG. 2 is a block view illustrating a configuration of a health information processing device shown in FIG. 1;

FIG. 3 is a flowchart illustrating a method of diagnosing health data of a user according to an embodiment of the present invention;

FIG. 4 is a flowchart illustrating a method of correcting a disease probability of the user according to an embodiment of the present invention;

FIG. 5 is a view illustrating a location information table displaying mean disease factors with respect to transmittable diseases in areas divided according to locations;

FIG. 6 is a flowchart illustrating a method of correcting a disease probability of the user according to another embodiment of the present invention;

FIG. 7 is a view illustrating a node graph displaying transmittable a disease probability depending on social relations of the user; and

FIG. 8 is a flowchart illustrating a method of correcting a disease probability of the user according to still another embodiment of the present invention.

### DETAILED DESCRIPTION OF PREFERRED EMBODIMENTS

Both above general description and following detailed description are exemplary to provide additional descriptions for claims of the present invention. Accordingly, the present invention is not limited to the embodiments described below and may be embodied in other forms. The embodiments that will be described hereafter are provided to allow the disclosure to be thoroughgoing and perfect and to allow a person skilled in the art to fully understand the scope of the present invention.

In the present specification, when it is mentioned that a part includes an element, it means that the part may further include another element in addition thereto. Hereinafter, the embodiments of the present invention will be described in detail with reference to the attached drawings.

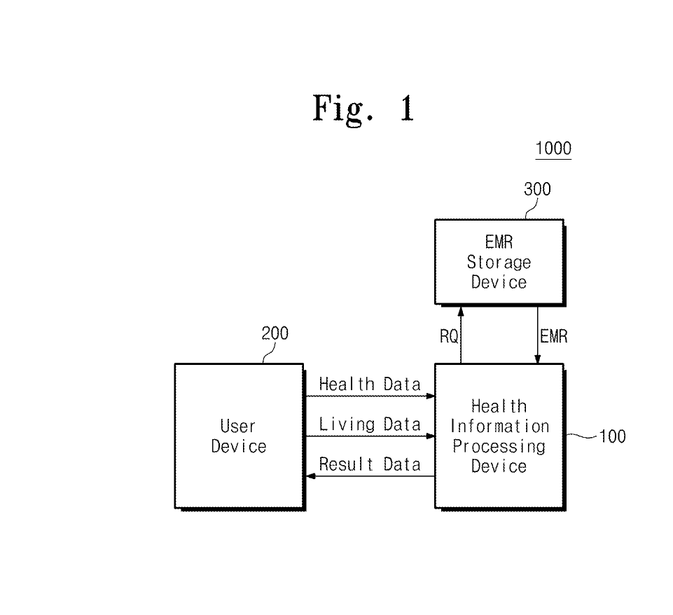

FIG. 1 is a block view illustrating a health management system 1000 according to an embodiment of the present invention. Referring to FIG. 1, the health management system 1000 includes a health information processing device 100, a user device 200, and an electric medical record storage device 300.

The user device 200 collects health data and living data from a user and provides the same to the health information processing device 100. For example, the user device 200 may collect measured data from a measuring device measuring health information of the user or u-health data measuring devices such as a sphygmomanometer, a weighing machine, and a blood sugar meter and may provide collected measured data as the health data.

As an example, the user device 200 may include a set-top box, a TV, a cellular phone, or a tablet PC as an electronic device having data transmission function.

Also, the user device 200 collects health data and living data from the user and provides the same to the health information processing device 100. Although it will be described below, the living data may include location information showing an area where the user is located or human connection information showing personal relations and human contacts of the user.

As an example, the living data may be collected from a device, which the user carries, and may be transmitted to the user device 200. Otherwise, the user device 200 may collect the living data based on information inputted into the user device 200 directly by the user.

The electric medical record storage device 300 stores computerized medical records of clinics as electric medical records (EMR). Also, responding to a request RQ from the health information processing device 100, a stored EMR is provided to the health information processing device 100.

The health information processing device 100 performs statistical analysis based on the EMR provided from the electric medical record storage device 300 and determines an estimation function estimating a disease probability according to a result of the statistical analysis. Also, the health information processing device 100 applies the determined estimation function to the health data of the user and calculates the disease probability of the user.

Also, the health information processing device 100 may provide a clinical diagnosis result according to the calculated disease probability of the user to the user device 200 as result data.

Otherwise, the health information processing device 100 may correct the calculated disease probability of the user with reference to the living data. Also, a clinical diagnosis result based on the corrected disease probability may be provided to the user device 200 as result data.

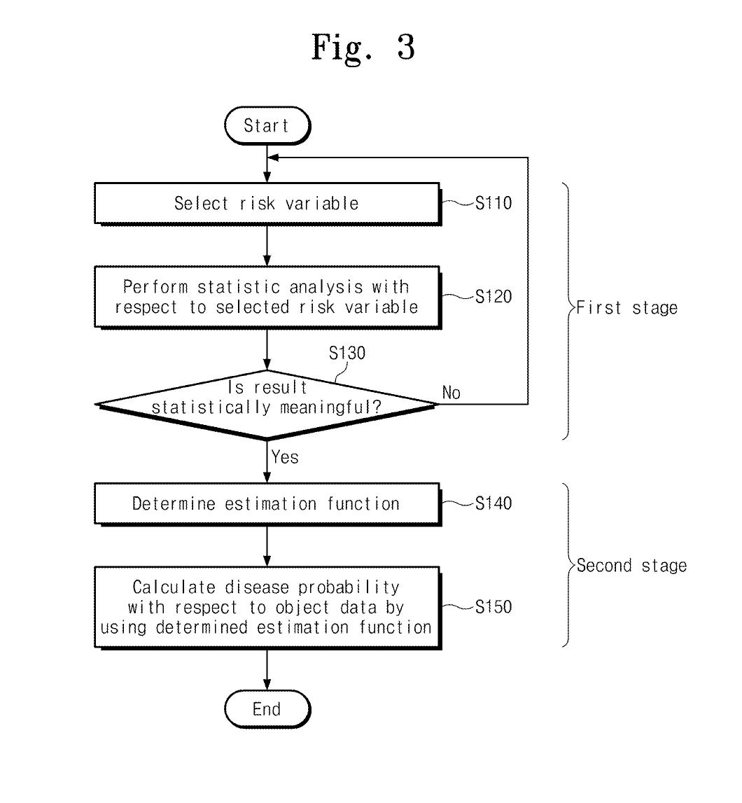

Detailed descriptions on a method of determining an estimation function and a method of correcting a disease probability of a user with reference to living data will be described below with reference to FIG. 3.

As an example, a calculated disease probability may be stored in an additional storage device inside the health information processing device 100.

According to a configuration as described above, the health management system 1000 may estimate the disease probability of the user by analyzing health data of the user, based on the estimation function determined statistically analyzing the electric medical record. Also, the health management system 1000 may improve accuracy of an estimated disease probability by correcting the disease probability of the user by referring the living data of the user.

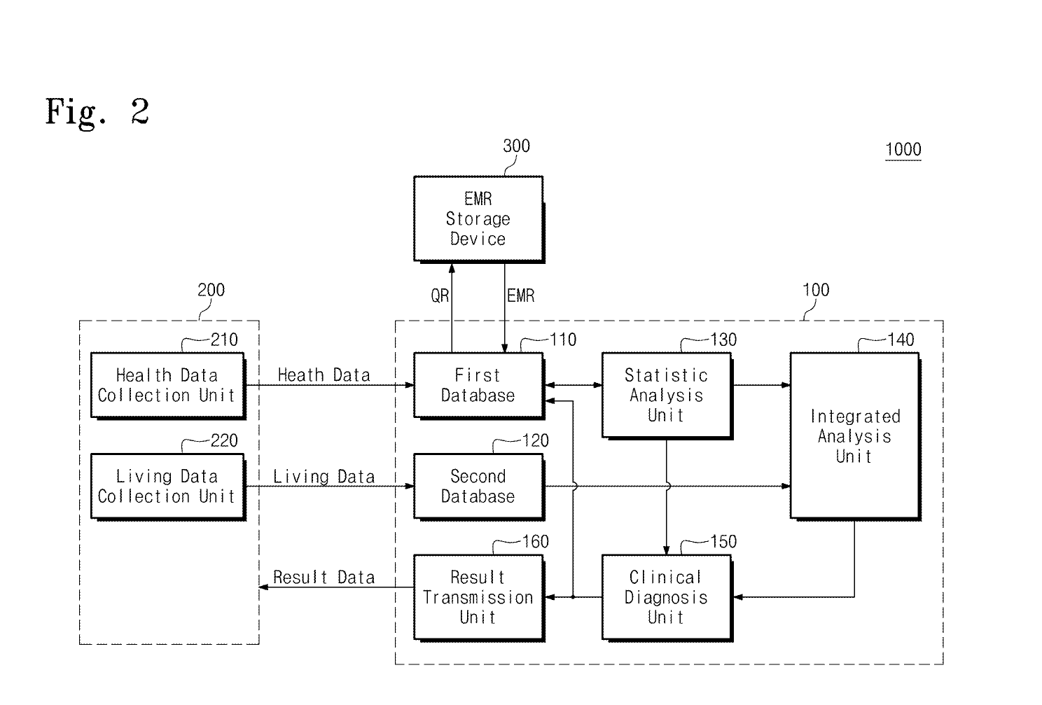

FIG. 2 is a block view illustrating a configuration of a health information processing device 100 shown in FIG. 1. Referring to FIG. 2, the health information processing device 100 includes a first database 110, a second database 120, a statistic analysis unit 130, an integrated analysis unit 140, a clinical diagnosis unit 150, and a result transmission unit 160.

The first database 110 stores the health data of the user, transmitted from the user device 200. As an example, the health data may be provided from a health data collection unit 210 of the user device 200.

Also, the first database 110 stores an EMR transmitted from the electric medical record storage device 300. As an example, the first database 110 may transmit a request signal RQ to the electric medical record storage device 300 and may receive and store an EMR provided in response to the transmitted request signal RQ.

The second database 120 stores the living data of the user, transmitted from the user device 200. As an example, the living data may be provided from a living data collection unit 220 of the user device 200.

On the other hand, it has been described that the first database 110 and the second database 120 are storage devices distinguished from each other but the present invention is not limited thereto. For example, the health data, the living data, and the EMR may be stored in the same database.

The statistic analysis unit 130 determines an estimation function by statistically analyzing the EMR stored in the first database 110 and calculates a disease probability of the user by applying the estimation function to the health data of the user. A detailed method of determining the estimation function performed by the statistic analysis unit 130 will be described below. As an example, the disease probability of the user, calculated by the statistic analysis unit 130, may be stored in the first database 110.

On the other hand, the statistic analysis unit 130 may provide the disease probability of the user to the clinical diagnosis unit 150 to use the same to clinically diagnose the user.

On the other hand, for more accurate clinical diagnosis, the statistic analysis unit 130 may provide the calculated disease probability of the user to the integrated analysis unit 140.

The integrated analysis unit 140 corrects the disease probability calculated by the statistic analysis unit 130 to more accurately estimate occurrence of disease of the user. In detail, the integrated analysis unit 140 corrects the calculated disease probability with reference to the living data stored in the second database 120. In this case, the living data indicates location information or social information of the user. Accordingly, correction of the disease probability performed by the integrated analysis unit 140 may be particularly effective to diagnose transmittable diseases.

A detailed method of correcting the disease probability performed by the integrated analysis unit 140 will be described below.

The disease probability corrected by the integrated analysis unit 140 is provided to the clinical diagnosis unit 150 and is used for clinical diagnosis.

The clinical diagnosis unit 150 may determine a degree of risk of pathogenesis of the user according to the disease probability of the user provided from the statistic analysis unit 130 or the integrated analysis unit 140 or may provide clinical remarks as a diagnosis result.

For example, the clinical diagnosis unit 150 may determine a risk of pathogenesis to be high when the disease probability is greater than a reference value and may provide a pathogenesis alert and a responding step against thereto as the diagnosis result.

Otherwise, the clinical diagnosis unit 150 may determine a risk of pathogenesis by combining the disease probability of the user with another environmental factor and may provide a pathogenesis alert and a responding step according to a determination result as the diagnosis result. For example, when a target disease is a seasonal disease, the clinical diagnosis unit 150 selects a present season, a climate, humidity, and a temperature as the environmental factor. Also, the clinical diagnosis unit 150 may determine the risk of pathogenesis of the user by considering a correlation between a selected environmental factor and the disease probability of the user.

The result transmission unit 160 transmits the diagnosis result transmitted from the clinical diagnosis unit 150 to the user device 200 as the result data. As an example, the result transmission unit 160 may include an additional communication module capable of performing wireless or wired communication.

As an example, the health information processing device 100 may selectively transmit the result data to the user only when the disease probability of the user is greater than a predetermined threshold.

According to the configuration as described above, the health management system 1000 may estimate the disease probability of the user by analyzing the health data or the living data of the user, based on the estimation function determined statistically analyzing the electric medical record. Also, the diagnosis result according to the estimated disease probability may be provided to the user.

FIG. 3 is a flowchart illustrating a method of diagnosing health data of a user according to an embodiment of the present invention. Referring to FIG. 3, the method of diagnosing the health data includes a first stage of determining an estimation function and a second stage of calculating a disease probability of the user by using the determined estimation function. Also, the first stage includes steps of S110 to S140 and the second stage includes a step S150.

In the step S110, the health information processing device 100 (refer to FIG. 2) determines a provisional estimation function according to a statistic analysis algorithm. The provisional estimation function means a certain function determined as a general expression according to the statistic analysis algorithm. For example, when the statistic analysis algorithm for estimating the disease probability is simple regression analysis, the provisional estimation function is determined as Yi=a+bXi that is a general form of a simple regression expression. In this case, i indicates a sample number of an electric medical record, Xi indicates a risk number, and Yi indicates a result value, for example, a degree of disease or a disease probability.

Also, some of various factors of the electric medical record are selected as risk variables of the provisional estimation function. For example, when a weight, blood pressure, and a cholesterol count of a patient are included in an electric medical record as risk factors, the health information processing device 100 may select some of them as risk variables of provisional estimation function.

In the step S120, the health information processing device 100 performs statistic analysis on the electric medical record according to the algorithm by applying the selected risk variables to the provisional estimation function. In this case, to determine whether the selected risk variables are suitable for statistic analysis or not, a correlation between the selected risk variables and a result value of an estimation function.

For example, it is assumed that the statistic analysis algorithm is the simple regression analysis and the provisional estimation function is set as Yi=a+bXi. In this case, to determine whether the selected risk variables are suitable for the simple regression analysis, a correlation between the risk variable values of sample data included in the electric medical record and the result values is compared with the provisional estimation function.

In the step S130, the health information processing device 100 determines whether the correlation between the risk variable values and the result values according to statistic analysis is statistically significant or not. For example, when a statistic analysis algorithm is simple regression analysis, a provisional estimation function is a linear function. On the contrary, when the risk variable Xi and the result value Yi are not linearly proportional to each other and an irregular correlation is shown therebetween, the selected risk variable is determined to be an unsuitable risk variable for the determined provisional estimation function.

A correlation between a risk variable value and a result value is statistically meaningful, the step S140 is performed in the method of diagnosing health data. Otherwise, in the method of diagnosing the health data, the step S110 is performed again to select a new risk variable.

In the step S140, the health information processing device 100 determines an estimation function by obtaining an undetermined coefficient of the determined provisional estimation function. For example, when the provisional estimation function is Yi=a+bXi, although the risk variable Xi is determined, a and b are left as undetermined coefficients. In the step S140, the health information processing device 100 determines the undetermined coefficient by using a statistical method. For example, the health information processing device 100 may use one of a least square method and a machine learning method as a method of obtaining the undetermined coefficients a and b. Since the least square method and the machine learning method are well known to a person skilled in the art, detailed descriptions thereof will be omitted.

Also, the estimation function is determined by substituting the obtained undetermined coefficients a and b are substituted for the provisional estimation function.

In the step S150, the health information processing device 100 applies the determined estimation function to the health data of the user and calculates the disease probability of the user. For example, the health information processing device 100 may calculate a result value thereof as the disease probability by substituting the risk variable values of the health data of the user for the determined estimation function. Otherwise, the health information processing device 100 may calculate the disease probability by multiplying a calculated result of substituting the risk variable values for the determined estimation function by a predetermined weighted coefficient.

On the other hand, although it has been described that the statistic analysis algorithm is the simple regression analysis as an example, the present invention is not limited thereto. For example, the statistic analysis algorithm may be one of regression analysis and support vector machine (SVM) algorithm.

A result obtained by the health information processing device 100 through the statistic analysis as described above is an estimated value by statistically estimating the disease probability according to the risk variable values of the user but is neither a definite measured value nor a detailed diagnosis result. However, the health information processing device 100 provides effective and cheap diagnosis services to the user by obtaining statistically meaningful a disease probability with no clinical determination of a doctor.

According to the configuration as described above, an estimation function for estimating a disease probability of a user may be determined and the disease probability of the user may be calculated according to the determined estimation function.

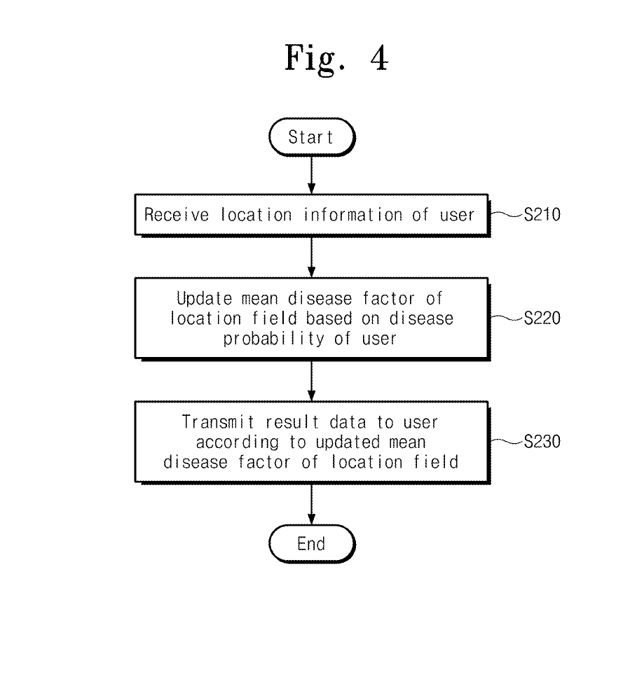

FIG. 4 is a flowchart illustrating a method of correcting a disease probability of the user according to an embodiment of the present invention. Referring to FIG. 4, the method of correcting the disease probability includes steps S210 to S230.

In the step S210, the health information processing device 100 receives location information of a user as living data. The received location information may be temporarily stored in the second database 120. The information stored in the second database 120 is provided to the integrated analysis unit 140. On the other hand, a disease probability of the user calculated by the statistic analysis unit 130 is provided to the integrated analysis unit 140.

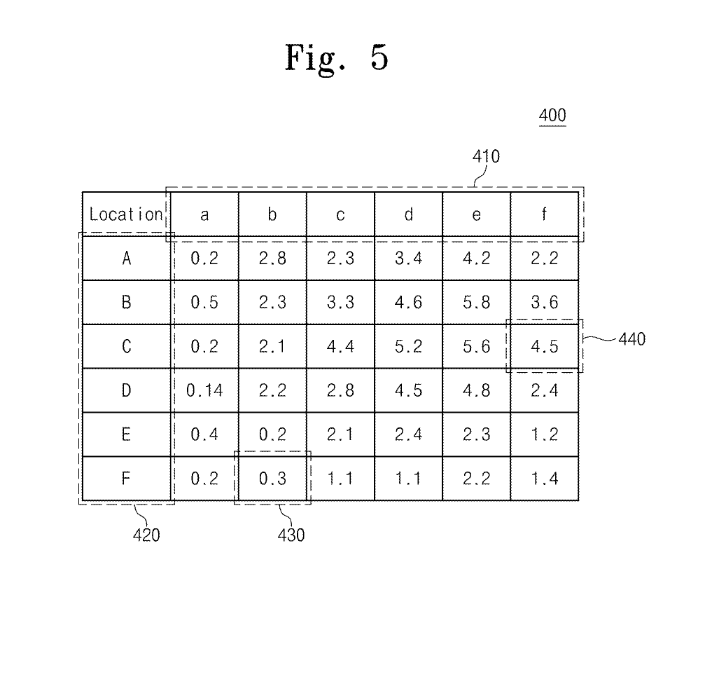

In the step S220, the health information processing device 100 updates a location field of a location information table based on the disease probability of the user. In this case, the location field includes a plurality of cells divided according to a plurality of areas and each of the plurality of cells records a mean disease factor of a corresponding area. The mean disease factor is a value indicating one of a mean disease occurrence degree and a degree of a risk of disease transmission in an area, calculated based on the disease probability of people located in the area. For example, the mean disease factor may be a mean disease probability of the people located in a corresponding area. Otherwise, the mean disease factor may be a value indicating transmissibility of the disease in the corresponding area. In this case, the mean disease factor may be calculated by adding all probabilities of diseases of people located in an area and dividing a total sum thereof by the number of the people located in the area. The location field, that is, the location information table in which the mean disease factor is shown is shown in detail in FIG. 5. In the present embodiment, updating the location field indicates updating the mean disease factor recorded in the location field.

The health information processing device 100 determines in which one of a plurality of preset areas (hereinafter, referred to as a target area) the user is located, according to the location information of the user. Also, the health information processing device 100 determines that the user is located in the target area, and a mean disease factor of the target area is updated based on the disease probability of the user. For example, when a mean disease factor is a mean disease probability of people located in an area, the health information processing device 100 recalculates a mean disease probability of all people located in the target area in addition to the user. Also, the recalculated disease probability is determined as the mean disease factor of the target area.

In the step S230, the health information processing device 100 corrects the disease probability of the user according to the updated mean disease factor of the location field and a diagnosis result based on the corrected disease probability to the user as result data.

As an example, the health information processing device 100 may selectively transmit the result data to the user only when the disease probability of the user is greater than a predetermined threshold.

In this case, the health information processing device 100 may correct the disease probability of the user as the same value as the mean disease factor of the target area. For example, when the mean disease factor in the target area is updated as 4, the disease probability of the user is corrected as 4 according to the updated mean disease factor.

Otherwise, the health information processing device 100 may correct the disease probability of the user by using the mean disease factor of the target area and a value obtained adding a predetermined weighting. For example, it is assumed that the mean disease factor of the target area is updated as 4 and the predetermined weighting is given by 0.1. In this case, the disease probability of the user may be corrected as a value to which the weighting (0.1)×the mean disease factor (4) has been added.

Otherwise, the health information processing device 100 may allow a mean value of the updated mean disease factor of the target area and the disease probability of the user to become a corrected disease probability of the user.

As described above, according to the updated mean disease factor, the method of correcting the disease probability of the user may be various and is not limited to the present embodiment.

According to the configuration as described above, the disease probability of the user is corrected according to the location information of the user. Accordingly, since the disease probability of the user is corrected according to a location of the user, it is possible to more accurately estimate occurrence of disease. Particularly, the method as described above may be useful to diagnose probability of transmittable diseases.

FIG. 5 is a view illustrating a position information table 400 displaying mean disease factors with respect to transmittable diseases in areas divided according to locations. Referring to FIG. 5, the location information table 400 includes a location field formed of a plurality of cells divided according to a first axis field 410 and a second axis field 420. As an example, the first axis field 410 may be a longitudinal field indicating the longitude and the second axis field 420 may be a latitude field indicating the latitude.

The location field of the location information table includes a plurality of cells divided according to a plurality of areas and each of the plurality of cells records a mean disease factor of a corresponding area. The mean disease factor and the location field are the same as described above. Mean disease factors recorded in the respective cells may have different values. Also, when a corresponding disease is transmittable, the distribution of the mean disease factor may be certain local characteristic. For example, the cells around a first cell 430 have relatively low mean disease factors. On the contrary, the cells around a second cell 440 have relatively high mean disease factors. As described above, transmittable diseases may have locally weighted mean disease factor distributions.

On the other hand, it is possible to update the mean disease factor of the location field based on the disease probability of the user according to an area where the user is located, as described above.

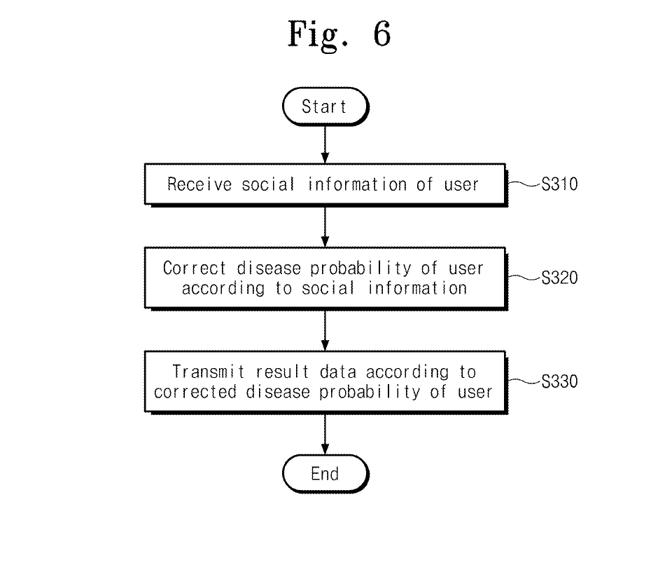

FIG. 6 is a flowchart illustrating a method of correcting a disease probability of the user according to another embodiment of the present invention. Referring to FIG. 6, the method of correcting a disease probability includes steps S310 to S330. In the present embodiment, the disease probability is corrected with reference to social information of the user.

In the step S310, the health information processing device 100 receives the social information of the user as living data. The social information designates human connections of the user. The social information may include information on people that the user frequently meets. Otherwise, the social information may include information on people having acquaintance with the user. For example, people in contact with the user through a social network service SNS may be considered to have predetermined human connections with the user.

In the case of the social information, depending on methods and numbers of contacts between peoples in contact with the user in reality or in cyberspace (hereinafter, referred to as objects), a predetermined weighting may be given to connections between the user and the objects. For example, an object in frequent contacts with the user through important communication means is determined to have relatively high intimacy with the user. In this case, a relatively high weighting may be given to a connection between the object and the user.

In the step S320, the health information processing device 100 determines an object and a connection weighting based on the social information of the user and corrects the disease probability of the user based on the determined object and weighting.

In detail, it is assumed that a weighting of 0.2 is given to the connection between the user and the object and a disease probability of the object is 1. In this case, the disease probability of the user is corrected by adding a value obtained by multiplying the weighting (0.2) by the disease probability of the object (1).

As an example, the user may have connections with a plurality of objects. In this case, the disease probability of the user may be corrected reiteratively according to the respective connections with the plurality of objects.

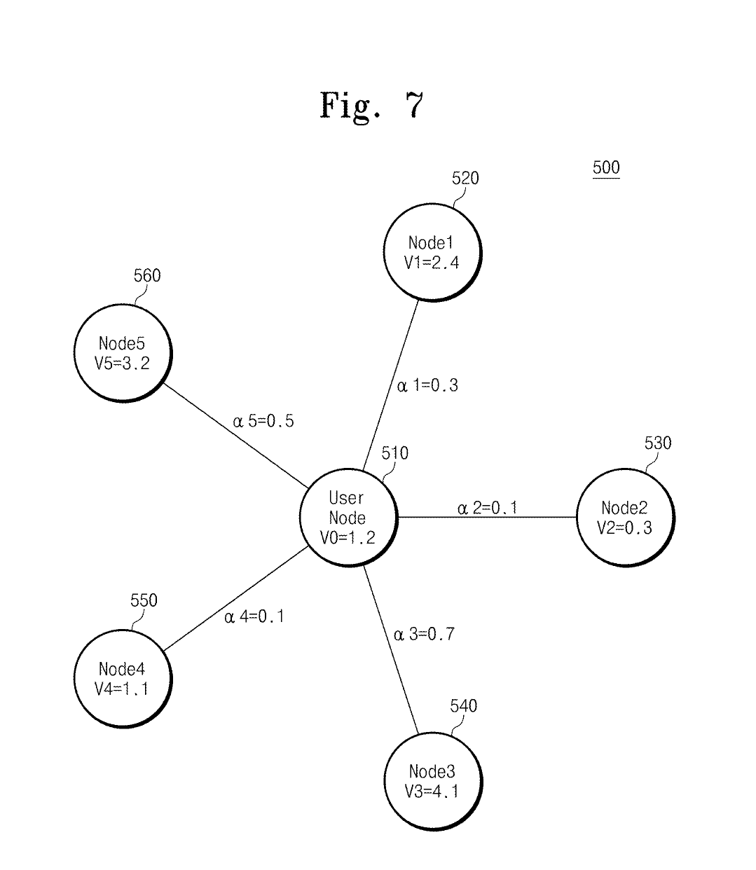

A detailed calculation method of correcting the disease probability of the user according to the social information will be described with reference to FIG. 7.

In the step S330, the health information processing device 100 transmits a result based on the corrected disease probability to the user as result data. As an example, the health information processing device 100 may selectively transmit the result data to the user only when the corrected disease probability of the user is greater than a predetermined threshold.

According to the configuration as described above, the probability of disease of the user is corrected according to the social information of the user. Accordingly, since the disease probability of the user is corrected according to contiguity probability of the user, it is possible to more accurately estimate occurrence of disease. Particularly, the method as described above may be useful to diagnose probability of transmittable diseases.

FIG. 7 is a view illustrating a node graph 500 displaying transmittable a disease probability depending on social relations of the user. Referring to FIG. 7, the node graph 500 includes a user node 510 and a plurality of object nodes 520, 530, 540, 550, and 560. The user node 510 and the plurality of object nodes 520, 530, 540, 550, and 560 are connected to one another, and a predetermined weighting is given to each connection.

In the present embodiment, a relation between the user and an object is shown as the node graph 500 but is not limited thereto. For example, the relation between the user and the object may be shown as a two-dimensional table. Otherwise, the relation between the user and the object may be shown as storage data in which a predetermined weighting is corresponding to a connection between the user and an object one by one.

Referring to FIG. 7, the user node 510 and the object nodes 520, 530, 540, 550, and 560 have disease probabilities V0, V1, V2, V3, V4, V5 thereof, respectively. Also, connections among the user node 510 and the object nodes 520, 530, 540, 550, and 560 have weightings α1, α2, α3, α4, and α5 differentiated according to contact means or the number of contacts with the objects.

Also, values obtained by multiplying the disease probabilities of the respective object nodes 520, 530, 540, 550, and 560 by the corresponding weightings α1, α2, α3, α4, and α5 are added to the disease probability V0 of the user node 510, thereby calculating corrected disease probabilities.

For example, it is assumed that the node graph 500 shown in FIG. 7 is determined In this case, to perform a correction according to the connection with the first node 520, a value obtained by multiplying the disease probability V1 by the weighting al (2.4×0.3=0.72) is added to the disease probability V0 of the user node 510.

Also, to perform a correction according to the connection with the second node 530, a value obtained by multiplying the disease probability V2 by the weighting α2 (0.3×0.1=0.03) is added to the disease probability V0 of the user node 510 reiteratively.

Similarly, corrections according to the connections with the third to fifth nodes 540, 550, and 560 are performed in the same method.

Accordingly, the disease probability of the user node 530 according to the node graph 500 may be corrected as follows.

A corrected disease probability=1.2+2.4×0.3+0.3×0.1+4.1×0.7+1.1×0.1+3.2×0.5

According to the node graph 500 as described above, the disease probability of the user may be corrected according to the connections between the user and the objects.

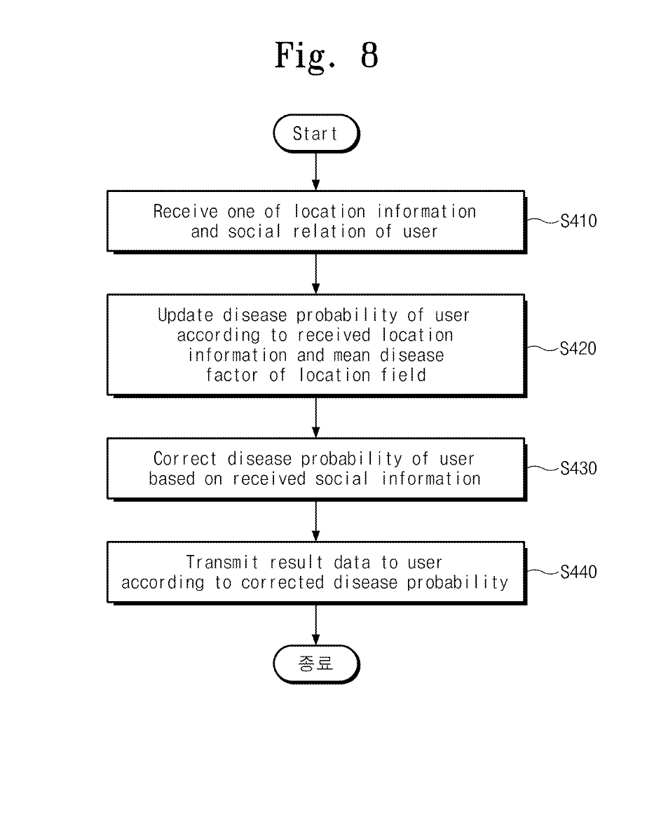

FIG. 8 is a flowchart illustrating a method of correcting a disease probability of the user according to still another embodiment of the present invention. Referring to FIG. 8, the method of correcting a disease probability includes steps S410 to S440. In the present embodiment, the disease probability is corrected with reference to location information and social information of the user.

In the step S410, the health information processing device 100 receives one of the location information and the social information of the user as health data. The details of the location information and the social information are the same as described above.

In the step S420, the health information processing device 100 updates a mean disease factor of a location field according to the received location information and the disease probability of the user. Also, the disease probability of the user is updated or corrected with reference to the updated mean disease factor.

A detailed method of updating the disease probability of the user is the same as described with reference to FIGS. 4 and 5.

In the step S430, the health information processing device 100 determines connections between the user and objects according to the received social information. To the respective connections, predetermined different weightings may be given. Also, based on the determined connections with the objects, updated or corrected disease probability of the user is corrected again.

A detailed method of correcting the updated or corrected disease probability of the user is the same as described with reference to FIGS. 6 and 7.

In the step S430, the health information processing device 100 transmits a diagnosis result to the user as result data according to the disease probability of the user, corrected in the step S430.

As an example, the health information processing device 100 may selectively transmit the result data to the user only when the corrected disease probability of the user is greater than a predetermined threshold.

According to the configuration as described above, the disease probability of the user is corrected according to the location information and the social information of the user. Accordingly, since the disease probability of the user is corrected according to contiguity probability of the user, it is possible to more accurately estimate occurrence of disease. Particularly, the method as described above may be useful to diagnose probability of transmittable diseases.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A health management system comprising:
a user device collecting and providing health data and living data of a user; and
a health information processing device calculating a disease probability of the user by performing statistic analysis based on an electric medical record and the health data and correcting the calculated disease probability according to the living data,
wherein the living data comprises one of location information of the user and social information of the user, which designates a human connection.

2. The system of claim 1, wherein the health information processing device calculates a mean disease factor of a predetermined area based on disease probabilities of people located in the predetermined area and determines whether the user is located in the predetermined area with reference to the living data, and
wherein, when the user is located in the predetermined area, the mean disease factor is updated with reference to the disease probability of the user and the disease probability of the user is corrected according to the updated mean disease factor.

3. The system of claim 1, wherein the health information processing device determines contiguity of the user and an object with reference to the living data and corrects the disease probability of the user with reference to the contiguity and a disease probability of the object.

4. The system of claim 3, wherein the living data comprises a social relation between the user and the object in a social network service (SNS).

5. The system of claim 1, wherein the health information processing device comprises a database storing one of the health data and the living data.

6. The system of claim 1, wherein the disease probability is a probability of a transmittable disease.

7. The system of claim 1, wherein the health information processing device provides a clinical diagnosis result to the user device, based on the calculated disease probability of the user.

8. The system of claim 1, wherein the health information processing device determines an estimation function according to a result of performing the statistic analysis and calculates the disease probability of the user by applying the determined estimation function to the collected health data.

9. The system of claim 8, wherein the health information processing device selects at least one of a plurality of risk variables as a variable of a provisional estimation function, performs the statistic analysis with respect to a result of applying the provisional estimation function to the electric medical record, and determines the provisional estimation function to be the estimation function according to a result of performing the statistic analysis.

10. The system of claim 9, wherein the statistic analysis is performed by using one of regression analysis and a support vector machine (SVM) algorithm.

11. The system of claim 1, further comprising an electric medical record storage device storing the electric medical record and providing the electric medical record to the health information processing device in response to a request of the health information processing device.

12. A method of providing health information of a health management system, the method comprising:
calculating disease probability of a user by statistically analyzing an electric medical record and health data of the user;
correcting the disease probability of the user with reference to living data of the user; and
providing a clinical determination with respect to a disease to the user according to the corrected disease probability,
wherein the living data comprises one of location information of the user and social information of the user, designating a human connection.

13. The method of claim 12, wherein the correcting the disease probability comprises:
updating a mean disease factor showing a risk of disease transmission of an area in which the user is located, with reference to the location information of the user and the disease probability of the user; and
correcting the disease probability of the user according to the updated mean disease factor.

14. The method of claim 12, wherein the correcting the disease probability comprises:
determining contiguity between the user and an object with reference to the social information; and
correcting the disease probability of the user with reference to the contiguity and a disease probability of the object. 10

15. The method of claim 12, wherein the calculating the disease probability comprises:
selecting some of a plurality of risk variables;
verifying a correlation between the selected risk variable and the disease probability by statistically analyzing the electric medical record according to the selected risk variable;
determining an estimation function comprising the selected risk variable according to a verification result; and
calculating the disease probability of the user by applying the estimation function to the health data of the user.
